(19) United States
(12) Patent Application Publication
(10) Pub. No.: US 2008/0043722 A1
(43) Pub. Date: Feb. 21, 2008

(54) Extension network system and dialing and answering processes of the same

(76) Inventors: Chih-Hsin Chuang, Taipei City (TW); Rong-Chin Yang, Taipei City (TW)

Correspondence Address: RABIN & Berdo, PC, 1101 14TH STREET, NW, SUITE 500, WASHINGTON, DC, 20005, US

(21) Appl. No.: 11/498,731

(22) Filed: Aug. 4, 2006

(51) Int. Cl. H04L 12/66

(52) U.S. Cl. 370/352

(57) ABSTRACT

A user self-expandable extension network system and its dialing and answering processes are applied to an extension network which consists of a plurality of extensions. An extension will send a detecting signal to locate the host phone and regard the host phone as a session initiation protocol (SIP) proxy server after receiving the reporting signal of the host phone. Therefore, the extension can be dialed or receive a phone call without being set up by the assistance of a professional technician.

### BACKGROUND OF THE INVENTION

1. Field of Invention

The present invention relates to an extension network system and a dialing and answering method of the same, and more particularly to an IP phone extension network in which the extension will detect a host phone and assign it as a session initiation protocol proxy server, and a dialing and answering method of the same.

2. Related Art

An IP phone relates to a telephone communication technology, which uses a voice over internet protocol (VoIP) by an internet or IP network technology.

A session initiation protocol (SIP) relates to an application level control protocol, which establishes a VoIP connection by applying a request-response structure for one or more participants to start, correct, or end a conversation. Since the SIP only involves processing the signal part of a conversation, the SIP usually works with other protocols, such as a real-time transport protocol (RTP), to transmit a voice or an image of the communication. Still, some operations in the SIP are similar to those in traditional telephones, such as dialing, ringing or being busy. The SIP uses a proxy server to provide functions, such as a registration and/or inquiring a route to the target party. The registration plays an important role in the SIP since every IP phone has its own identification. Therefore, registering its unique identification to a proxy server makes the proxy server capable of identifying each IP phone.

In the past, most IP phones were used in the internal network of large companies or organizations for managing technicians, to simultaneously provide a voice and a data service through a network. As the Internet has become popular and the demand of long distance communication has increased dramatically, the IP phone has applied to be used in long distance communication. In addition, since competition between the telecommunication companies of the major cities of the world is getting intense and since the telecommunication regulation has been modified, the IP phone has started to be used in a fixed network communication. Due to the advantages of low communication cost, low equipment cost, capable of expansion and improving quality of conversation, replacing a traditional phone with the IP phone becomes a trend either in enterprises or families. Therefore, the international telecommunication enterprises often regard the IP phone as a potential competitor of the traditional telecommunication technique.

In the current IP phone network, an extension number is associated with a unique IP address, which in turn represents one IP device (e.g. IP Phone or gateway). If a person needs multiple phones at different locations, each phone will be assigned a different extension number. It is generally undesirable since the person wants to be reached by the same number especially in a private environment (e.g. different rooms of the house) and it is difficult to memorize the correct phone number to dial for the different location. If multiple phones, placed at different locations, need to share the same extension number, it can only be accomplished by a hunt group or a forward process. However, the above processes need a server capable of providing such functions and also need a professional technician to set it up correctly. The IP phone can not, like a traditional phone, be set up by persons buying a telephone and connect it themselves when they want a private phone extension network. Therefore, it is inconvenient to set up an IP extension phone, except for processional technicians.

### SUMMARY OF INVENTION

It is an object of the present invention to provide a private extension network system and method in order to let the IP extension be shared by multiple phones without being set up by a professional technician.

An embodiment of a dialing process includes the following steps: an extension sending a request to a host phone; the host phone modifying the identification data in the request to represent itself and sending the modified request to a SIP proxy server; after receiving a response from the SIP proxy server, the host phone sending the response to the extension which sends the request, and the extension receiving the response from the host phone.

An embodiment of an answering process includes the following steps: after receiving a request from a SIP proxy server, the host phone sending the request to all extensions; after one of the extension is connected through, a response sent by the extension to the host phone; after receiving the response, the host phone sending a cancel ringing signal to the extensions which are not connected through.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1 is a structural diagram of an extension network system, in which a user may expand it by himself according to the invention;

FIG. 2A is a registration process flowchart of an extension network system, in which a user may expand it by himself according to the invention;

FIG. 2B is a dialing process flowchart of an extension network system, in which a user may expand it by himself according to the invention;

FIG. 2C is an answering process flowchart of an extension network system, in which a user may expand it by himself according to the invention;

FIG. 3A is a diagram showing an original extension network logical connection according to the invention; and

FIG. 3B is a diagram showing a self-expanded extension network logical connection according to the invention.

### DETAILED DESCRIPTION

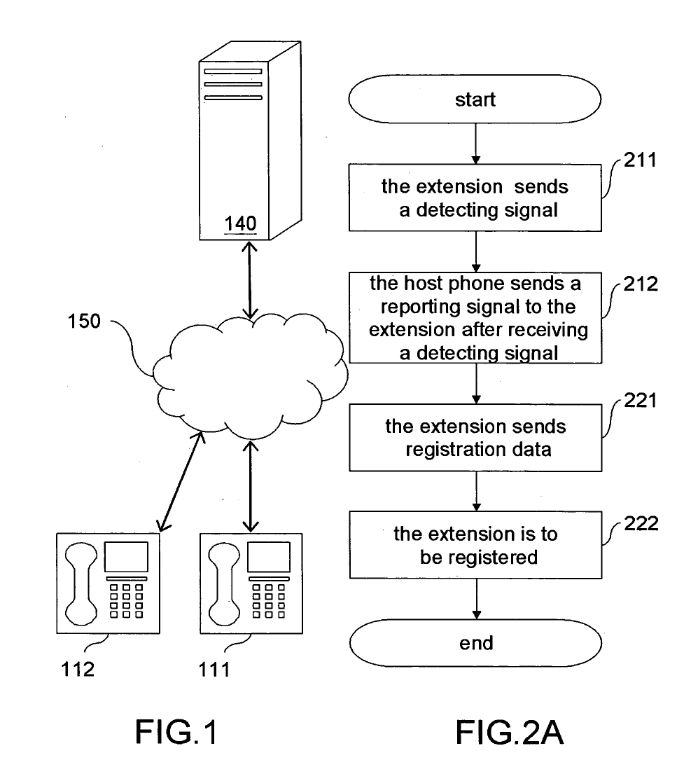

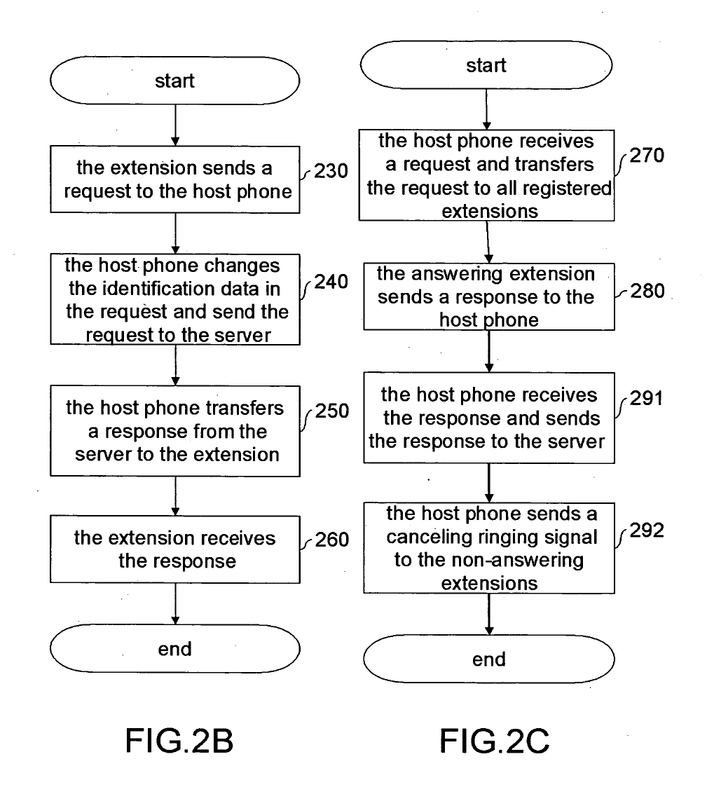

FIG. 1 is a diagram showing an embodiment of a system according to the present invention. The present invention includes a host phone 111 and a first extension 112. The host phone 111 establishes a logical connection with the first extension 112 by a network 150, and in the meantime, the host phone 11 also establishes a logical connection with a session initiation protocol (SIP) proxy server 140 by the network 150. Also refer to FIG. 2B. When the first extension 112 is dialed, the first extension 112 will send a request to the host phone 111 (step 230). After the host phone 111 receives the request from the first extension 112, the host phone 111 will change the identification data in the request from the representing first extension 112 to the representing host phone 111, and send the modified request to the SIP proxy server 140 (step 240). The host phone 111 will then transfer a response from the SIP proxy server 140 to the first extension 112, which responds to the request transferred from the first extension 112 to the SIP proxy server 140 by the host phone 111 (step 250). The first extension 112 will receive the expected response (step 260), and be capable of communicating. Based on FIG. 1 and FIG. 2C, when there is a coming call, the host phone 111 will receive a request transferred from the SIP proxy server 140 and transfer the request to the first extension 112 (step 270). When the first extension 112 connects through, it will send a response corresponding to the request to the host phone 111 (step 280). The host phone 111 will receive the response from the first extension 112 and send the modified response to the SIP proxy server 140 after changing the identification data in the response from the representing first extension 112 to the representing host phone 111 (step 291) and then wait for connection.

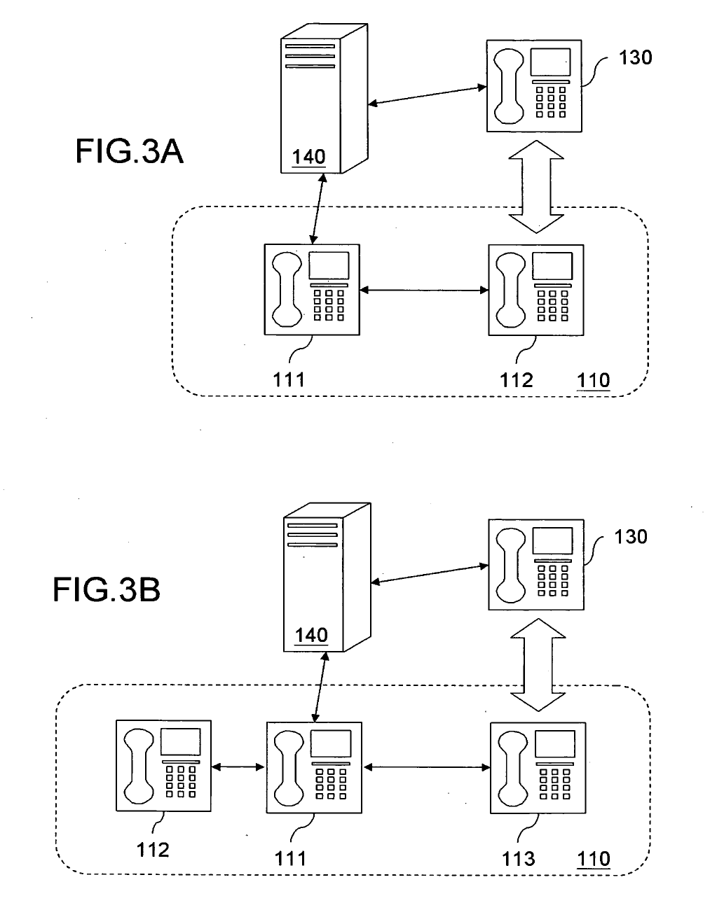

FIG. 3A is an illustrative embodiment of the system and the process according to the present invention. When a first user wants to make a phone call from a Hotel suite to a IP phone 130 of his house by the first extension 112 on the desk, the first extension 112 will send a first request ┌INVITE SIP: desk@room.hotel.tw SIP/2.0┘ to the host phone 111 beside the bed of the Hotel suite. The host phone 111 will change the identification data ┌desk┘ in the first request to its own identification data ┌bed┘, and send the modified first request ┌INVITE SIP: bed@room.hotel.tw SIP/2.0┘ to the SIP proxy server 140 of the hotel. Then, the first request will be transmitted through the internet to reach the IP phone 130 of the first user's house. The IP phone 130 will start ringing. When a second user picks up the IP phone 130, the IP phone 130 will send a first response ┌200, OK┘, which is transmitted through the internet to the SIP proxy 140 of the hotel. The SIP proxy server 140 will transfer the first response to the host phone 111 beside the bed and the host phone 111 will then transfer the first response to the first extension 112 on the desk so that a connection is established. The first extension 112 transmits the voice data to the IP phone 130 by RTP.

When the second user wants to use the IP phone 130 to make a phone call to the first user in the Hotel, the IP phone 130 will send a second request, which is similar to the first request, to the SIP proxy server 140 of the hotel through the internet. After receiving the second request, the SIP proxy server 140 will transfer the second request to the host phone 111, and the host phone 111 will transfer the second request to the first extension 112 after receiving the second request from the SIP proxy server 140. As a result, the first extension 112 will start ringing. When the first user picks up the first extension 112, the first extension 112 will send a second response ┌200, Ok┘ to the host phone 111. The host phone 111 will transfer the second response to the SIP proxy server 140 after it received the second response. Then connection is established. The first extension 112 transmits the voice data to the second IP phone 130 by RTP.

If a second extension 113 is installed in the bathroom of the suite with respect to FIG. 3B and FIG. 2A, the second extension 113 will send a detecting signal in order to detect the host phone 111 after it has been connected to the internet (step 211). The detecting technology is not limited to the UDP discovery packet. If the UDP discovery packet is used to detect the host phone 111, the second extension 113 and the host phone 111 must have the same IP subnet 110; Otherwise, the UDP discovery packet can not correctly reach the host phone 111 and the second extension 113 may not be capable of detecting the host phone 111. The host phone 111 will send a reporting signal to the second extension 113 after it received the detecting signal from the second extension 113 (step 212). After receiving the reporting signal from the host phone 111, the second extension 113 will send registration data to the host phone (step 221) and the host phone will record the data of the second extension 113 to complete the registration (step 222).

By the same process as described above, the first user may dial or pick up the phone in the bathroom. However, one more step is necessary for answering the phone call with respect to FIG. 2C. After step 291, the host phone 111 will send a canceling ringing signal to other extensions, which do not send the second response (step 292). For example, when the host phone 111 transfers the second request to the first extension 112 and the second extension 113, the first extension 112 and the second extension 113 start ringing. After the first user has picked up the second extension 113, the second extension 113 will send the second response to the host phone 111 and the host phone 111 will send a canceling ringing signal to other extensions that do not send the second response, which will be the first extension 112 in this embodiment. Therefore, the first extension 112 will stop ringing and the second extension 113 will transmit the voice data to the second extension 113 by the RTP.

While the illustrative embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

The present invention provides an extension network system by which a user can expand it himself. In the IP phone extension network, the extension will send a detecting signal to detect the host phone. When the host phone has received the detecting signal, it will send a reporting signal to the extension which sends the detecting signal and register the extension through the session initiation protocol (SIP) proxy server. Therefore the extension doesn't need a technician to transmit a request and a response with a host phone to process dialing and answering.

What is claimed is:

1. An expandable extension network system, wherein one of plural internet protocol (IP) phones is a host phone and the other IP phones are extensions and the host phone connects to a session initiation protocol (SIP) proxy server by a network, the system comprising:
a host phone is used for receiving a detecting signal from one of the extensions and sending a reporting signal to the extension which sends the detecting signal, for receiving a registration data from one of the extensions and registering the extension, for receiving a first request from one of the extensions and transferring a modified data to the SIP proxy server after modifying an identification data in the first request from representing the extension to representing the host phone, for receiving a first response which corresponds to the first request from the SIP proxy server and sending the first response to the extension, for receiving a second request from the SIP proxy server and packet transferring the second request to all extensions, and for receiving a second response from one of the extensions and transferring the second response to the SIP proxy server; and
at least one extension is used for sending a detecting signal to locate the host phone, for receiving the reporting signal from the host phone and sending the registration data to the host phone, for sending the first request to the host phone, for receiving the first response transferred from the host phone, for receiving the second request transferred from the host phone, and for sending the second response to the host phone when the extension is connected through.

2. The system of claim 1, wherein the host phone and the extensions are in the same subnet.

3. The system of claim 1, wherein the extensions further comprises receiving a canceling ringing signal.

4. The system of claim 3, wherein the host phone further comprising sending the canceling ringing signal to the extensions which do not send the second response after receiving the second response.

5. A dialing process of expandable extension network, wherein one of plural internet protocol (IP) phones is a host phone and the other IP phones are extensions and the host phone connects to a session initiation protocol (SIP) proxy server by a network, the process comprising the following steps:
sending a request to the host phone from one of the extensions;
modifying an identification data in the request from representing the extension to representing the host phone and transferring the modified request to the SIP proxy server by the host phone;
receiving a response which corresponds to the request from the SIP proxy server and transferring the response to the extension by the host phone; and
receiving the response by the extension.

6. The dialing process of claim 5, further comprising the following steps:
sending a detecting signal to locate the host phone by the extension, after receiving the detecting signal, the host phone sending a reporting signal to the extension which sends the detecting signal; and
registering the extension by the host phone.

7. The dialing process of claim 5, wherein the host phone and the extensions are in the same subnet.

8. A answering process of expandable extension network, wherein one of plural internet protocol (IP) phones is a host phone and the other IP phones are extensions and the host phone connects to a session initiation protocol (SIP) proxy server by a network, the process comprising the following steps:
receiving a request from the SIP proxy server and transferring the request to the extensions by the host phone;
sending a response to the host phone when one of the extensions is connected through; and
receiving the response and transferring the response to the SIP proxy server by the host phone.

9. The answering process of claim 8, further comprising the following steps:
sending a detecting signal to locate the host phone by the extension, after receiving the detecting signal, the host phone sending a reporting signal to the extension which sends the detecting signal; and
registering the extension by the host phone.

10. The answering process of claim 8, wherein the host phone and the extensions are in the same subnet.

11. The answering process of claim 8, further comprising a step of the host phone sending a canceling ringing signal to the extensions which do not send the response after the host phone receiving the response.
